(19) United States
(12) Patent Application Publication
(10) Pub. No.: US 2004/0061684 A1
(43) Pub. Date: Apr. 1, 2004

(54) System and method for remote display

(76) Inventor: Angelo Tortola, Lexington, MA (US)

Correspondence Address: JOSEPH STECEWYCZ, P.O. BOX 1309, GROTON, MA, 01450, US

(21) Appl. No.: 10/606,153

(22) Filed: Jun. 25, 2003

Related U.S. Application Data
(60) Provisional application No. 60/391,325, filed on Jun. 25, 2002.

(51) Int. Cl. G09G 5/00

(52) U.S. Cl. 345/169

(57) ABSTRACT

A remote display system includes a base station for transmitting a data output signal for display at one or more remote display devices. The base station includes a computer for providing the data output signal, a control processor for converting the data output signal into a control and data interface RF signal, and an RF transmitter for broadcasting the control and data interface signal. The display device includes an RF receiver for receiving the control and data interface signal, a display controller for converting the control and data interface signal into the data output signal, and a display unit for displaying the data output signal. The remote display system may also function in a full duplex mode to transmit to the base station feedback signals originating from a proximity sensor or a touch-screen provided at the display unit.

### CROSS REFERENCE TO RELATED APPLICATION

The present Application is related to Provisional Patent Application serial No. 60/391,325 entitled “System and Method for Remote Display” and filed Jun. 25, 2002.

### FIELD OF THE INVENTION

The invention relates to remote display of information and, in particular, to a system and method for providing efficient textual and graphical displays.

### BACKGROUND OF THE INVENTION

Conventional marketing and advertising displays provided at the point of sale are typically printed text and illustrations. Changing such displays to adapt to market trends or to provide notice of limited-time offers and savings thus requires diversion of personnel to physically make the change. What is needed is a system and method to remotely control textual and graphical displays.

### SUMMARY OF THE INVENTION

A remote display system is disclosed which includes a base station for transmitting a data output signal for display at one or more remote display devices. The base station includes a computer for generating the data output signal. The data output signal is converted into a control and data interface RF signal by a control processor which receives the data output signal from the computer. Alternatively, the data output signal may be supplied to the computer via an Internet connection. An RF transmitter broadcasts the control and data interface signal to the remote display devices at a high RF frequency (e.g., 400 to 900 MHz) within non-regulated power levels. Each display device includes an RF receiver for receiving the control and data interface signal. The control and data interface signal is converted via a display controller back into the data output signal. The data output signal is then provided to a display unit, such as a monitor, an LCD screen, or a scrolling display, for viewing by a remote user. The remote display system may also function in a full duplex mode to transmit to the base station feedback signals originating from a proximity sensor or a touch-screen provided to the user at the display unit.

### BRIEF DESCRIPTION OF THE DRAWINGS

Other objects and advantages of the present invention will be more readily apparent from the following detailed description when read in conjunction with the accompanying drawings in which:

FIG. 1 shows a system for providing remote display of information; and

FIG. 2 shows an alternative embodiment of the system of FIG. 1 operating in a full duplex mode.

### DETAILED DESCRIPTION OF THE INVENTION

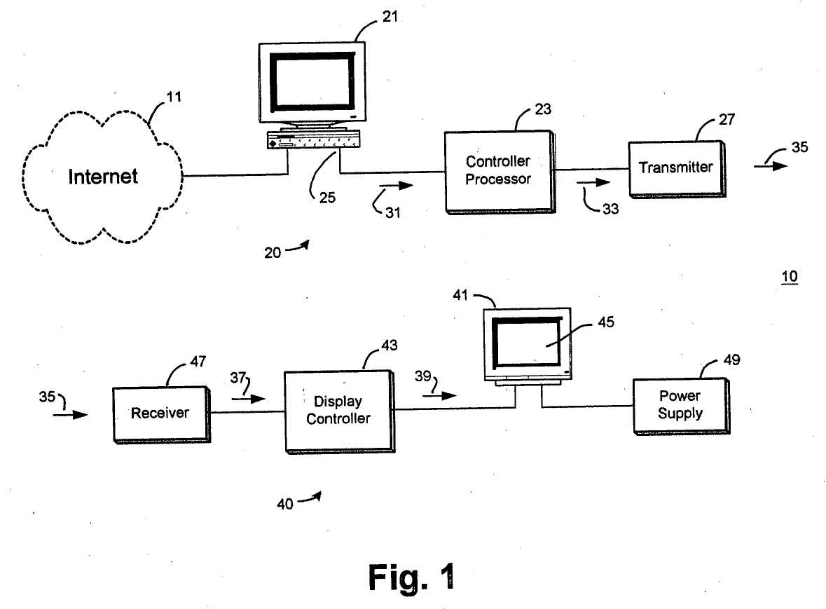

As shown in FIG. 1, a remote display system 10 includes a base station 20 disposed at a central location and one or more display devices 40 disposed in at least one remote user location. The base station 20 includes a computer 21, such as a PC or laptop, connected to a controller processor card 23, preferably via a PC interface port 25. The interface port 25 can be a serial or a parallel port, such as an RS232 connector port, a USB port, or any other connector port suitable for outputting serial or parallel data. The interface port 25 provides a data output signal 31 to the controller processor 23, wherein the data output signal 31 may comprise a display information signal for display at one or more display devices 40.

The controller processor 23 provides an RF control and data interface signal 33 to a transmitter 27. The controller processor 23 functions to broadcast an RF signal 35 via the transmitter 27, wherein the RF signal 35 preferably contains display information provided in the RF control and data interface signal 33.

The display information provided in the RF control and data interface signal 33 originates in the computer 21 and may be generated or retrieved therein by a computer operator (not shown). Alternatively, the display information, or updated display information, may be obtained from a remote server or operator via the internet 11.

The display device 40 includes a display unit 41 connected to a display controller 43. The display controller 43 serves to produce an image 45 on the display unit 41 from a data output signal 39, where the image 45 may be an advertisement, a banner, product data, or other such information made available to a user at the remote location. In a preferred embodiment, the image 45 is provided to the display controller 43 via a receiver 47.

The receiver 47 is configured to receive the RF signal 35 originating at the transmitter 27. When the RF signal 35 is received, the receiver 47 transmits a control and data interface signal 37 to a display controller 43 which sends the data output signal 39 to the display unit 41. The data output signal 39 is substantially similar to the data output signal 31 originating at the computer 21. Accordingly, the image 45 produced in the display unit 41 from the data output signal 39 is the same as the image which would have been produced if the data output signal 31 were provided directly to the display unit 41.

In a preferred embodiment, the transmitter 27 and the receiver 47 operate at an non-regulated power level at a high RF frequency, such as a 400 MHz frequency band or the 900 MHz frequency band used for cordless, or wireless, telephones. An RF operating frequency allows the display device 40 to be emplaced in an optimal location, such as for viewing by users or customers, without requiring a line-of-sight path between the transmitter 27 and the receiver 47. Moreover, this configuration enables the base station 20 to be placed at a site convenient for the computer operator, such as in the office of a supermarket or other retail facility, for example.

The display unit 41 can be any display device which provides a textural or graphic image corresponding to the information contained in the data output signal 31 provided by the computer 21. A power supply 49, such as a battery, solar cell, or other self-contained power source, can be used to provide power to the display unit 41, which can be a monitor, a liquid crystal display (LCD) screen or a scrolling display, for example. In a preferred embodiment, the display unit 41 comprises a device operating at a low or negligible rate of power consumption.

In a first preferred embodiment, the display unit 41 comprises an electrophoretic display, such as disclosed in U.S. Pat. No. 6,249,271 “Retroreflective Electrophoretic Displays and Materials for Making the Same,” issued to Albert et al. or U.S. Pat. No. 6,300,932 “Electrophoretic Displays with Luminescent Particles and Materials for Making the Same,” issued to Albert. As can be appreciated by one skilled in the relevant art, an electrophoretic display utilizes little or no electrical power to maintain an optical state in which an image is presented to a viewer.

In a second preferred embodiment, the display unit 41 comprises a bistable cholesteric LCD display, such as disclosed in U.S. Pat. No. 5,570,216 “Bistable Cholesteric Liquid Crystal Display with Very High Contrast and Excellent Mechanical Stability,” issued to Lu et al. or a cholesteric LCD display such as disclosed in U.S. Pat. No. 6,317,189 “High-efficiency Reflective Liquid Crystal Display,” issued to Yuan et al.

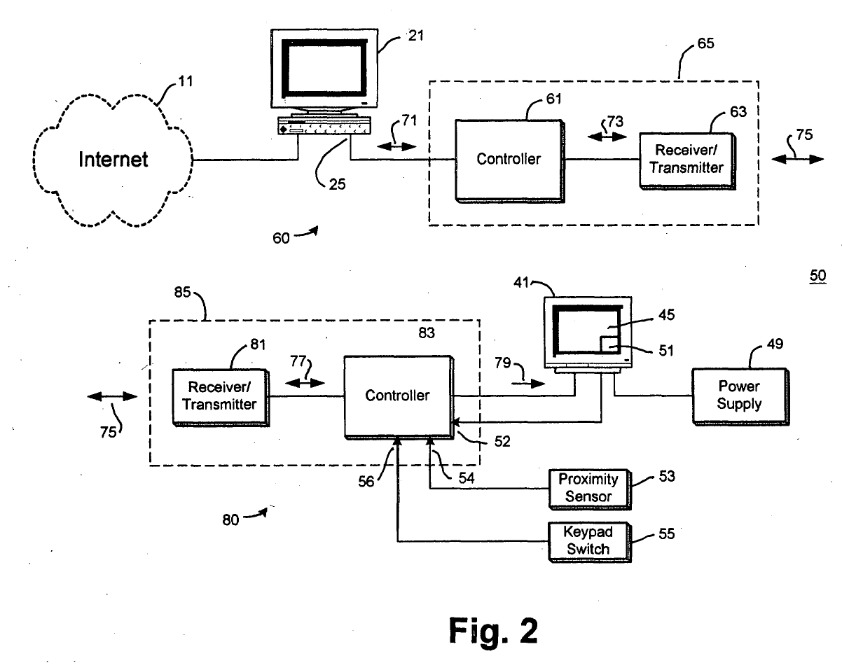

As shown in FIG. 2, an alternative system 50 operating in an interactive mode in full duplex communication includes a base station 60 disposed at a central location and one or more display devices 80 disposed in at least one remote user location. The base station 60 includes the computer 21 communicating with a controller 61. The computer 21 provides a data signal, indicated by duplex signal 71, to the controller 61, wherein the data signal may comprise a display information signal for display on one or more of the display devices 80.

The controller 61 communicates with a receiver/transmitter 63 via an RF control and data interface signal 73, and thereby functions to broadcast an RF signal 75 via the receiver/transmitter 63. The RF signal 75 preferably contains display information obtained from the RF control and data interface signal 73.

In a preferred embodiment, the controller 61 and the receiver/transmitter 63 are provided as a single RF subsystem 65 operating in full duplex mode. The RF subsystem 65 may comprise, for example, an RFOS™ operating software module available from Venture Technologies, North Billerica, Mass. The receiver/transmitter 63 may comprise, for example, an RF500 single-chip UHF transceiver operating at from 700 to 1100 MHz available from Micrel Semiconductor, San Jose, Calif. Preferably, the RF subsystem 65 is physically configured for direct attachment to the computer 21. However, it should be understood that neither the controller 61 nor the receiver/transmitter 63 need be located in proximity to the computer 21 for operation as disclosed herein.

The RF signal 75 is received by a receiver/transmitter 81 which subsequently communicates with a controller 83 via a control and data interface signal 77. The controller 83 sends a data output signal 79 to the display unit 41. The data output signal 79 is substantially similar to the data output signal indicated at 71 above such that the image 45 resulting on the display unit 41 is the same image corresponding to the display information contained in the data output signal indicated at 71. Preferably, the receiver/transmitter 81 and the controller 83 are provided as a single RF subsystem 85 operating in full duplex mode. As can be appreciated by one skilled in the relevant art, a single RF component can be configured to function either as the RF subsystem 65 or as the RF subsystem 85. Accordingly, the system 50 can be simplified by using two such RF components for the RF subsystem 65 and the RF subsystem 85.

The system 50 may further comprise a proximity sensor 53, such as an IR sensor, for providing user feedback to the controller 83, as indicated at 54. The proximity sensor 53 can be used in applications where the operator of the computer 21 wishes to obtain feedback on the effectiveness of the information being displayed at the display unit 41, for example. The controller 83 can be configured to read signals provided by the proximity sensor 53 to indicate, for example, which displayed information attracts the greatest number of customers (i.e., remote users), or the duration of time for which a particular display retains the attention of a particular customer.

Alternatively, there may be provided a touch-screen 51 at the display unit 41 to provide feedback from a user viewing the image 45. As the user makes selections on the touch-screen 51, a corresponding signal is sent to the controller 83, as indicated at 52. In yet another alternative embodiment, a keypad switch 55 is provided to enable the user to initiate feedback, as indicated at 56. The user feedback is transmitted to the receiver/transmitter 81, as indicated by duplex signal 77, and transmitted to the base station 60, as indicated by RF signal 75. The feedback is eventually received at the computer 21, as indicated by the duplex signal 71.

While the invention has been described with reference to particular embodiments, it will be understood that the present invention is by no means limited to the particular constructions and methods herein disclosed and/or shown in the drawings, but also comprises any modifications or equivalents within the scope of the claims.

What is claimed is:

1. A remote display system suitable for transmitting a data output signal for display at a remote location, said remote display system comprising:
a base station, said base station including
a computer for providing the data output signal,
a control processor for converting the data output signal into a control and data interface radio frequency (RF) signal,
an RF transmitter for broadcasting said control and data interface signal; and
at least one display device, each said display device including
an RF receiver for receiving said control and data interface signal,
a display controller for converting said control and data interface signal into the data output signal,
a display unit for displaying the data output signal.
